(19) United States
(12) Patent Application Publication
(10) Pub. No.: US 2007/0127458 A1
(43) Pub. Date: Jun. 7, 2007

(54) Data communication method for detecting slipped bit errors in received data packets

(75) Inventors: Barry Small, Los Altos, CA (US); Peter Chambers, Phoenix, AZ (US)

Correspondence Address: PATENT LAW GROUP LLP, 2635 NORTH FIRST STREET, SUITE 223, SAN JOSE, CA, 95134, US

(73) Assignee: Micrel, Inc.

(21) Appl. No.: 11/295,317

(22) Filed: Dec. 6, 2005

(51) Int. Cl. H04L 12/56

(52) U.S. Cl. 370/389

(57) ABSTRACT

A data communication method for transmitting a data packet from a transmitter to a receiver includes providing a key to the transmitter and the receiver where the key includes a K-bit data pattern sensitive to the location of each data bit in the data pattern; appending the key to the tail of the data packet; transmitting the data packet with the key; receiving data bits at the receiver to form a received data packet; retrieving K data bits from the tail of the received data packet; and determining if the K data bits match the key. If the K data bits match the key, a first output signal having a first state indicating that the data packet is acceptable is provided. If the K data bits do not match the key, the first output signal having a second state indicating that the data packet should be rejected is provided.

### FIELD OF THE INVENTION

The invention relates to a data communication method and, in particular, to a data communication method for detecting slipped bit errors in data packets.

### DESCRIPTION OF THE RELATED ART

In general, a data communication system transmits information from a transmitter over a communication channel to a receiver. FIG. 1 illustrates a conventional serial data communication system where the transmitter transmits data serially—one bit at a time—to the receiver over a communication channel. The information is often transmitted over a noisy or poor quality communication channel where the information being transmitted is often corrupted. Noisy communication channels can include telecommunication cables and wires which are subject to electrical interference or wireless communication channels such as radio frequency (RF) communication channels. Data transmission over a wireless communication channel is especially vulnerable to corruption.

Since most data communication systems require absolute integrity in the received information and often even a 1-bit error in the received information cannot be tolerated, conventional data communication systems implement some sort of error detection and/or error correction routines to check for and correct errors in the received information. For example, Cyclic Redundancy Check (CRC) and Error Detection And Correction (EDAC) algorithms are often implemented to improve the accuracy and reliability of the received information.

While many solutions exist in the industry to create robust communications systems that can tolerate noisy communication environments, these solutions are largely applicable to synchronous systems where the transmitted data arrives at the receiver at a predictable rate. In synchronous transmission systems, it is easy to determine if a bit can or cannot be correctly decoded and standard Forward Error Correction (FEC) or Error Detection And Correction (EDAC) algorithms may be used to recover the original data.

In an asynchronous communication system, the situation is made more difficult since the data does not arrive at the receiver at a known rate. Instead, the incoming data must be examined for transitions (edges) to see exactly where individual bits lie. The asynchronous nature of the received data makes it much harder to decode the received data where bits, or groups of bits, in the received data may be lost or corrupted. Furthermore, asynchronous communication systems are susceptible to “slipped bit” errors that results in additional bits being inserted into what otherwise would be a perfectly transmitted data packet. Data integrity can be severely compromised if these additional bits in the data packet are not detected as errors by the receiver.

Data transmission errors typically take the form of flipped bits or missed bits. A flipped bit error occurs when the receiver decodes the incoming data bits incorrectly so that a “0” is decoded as a “1” or a “1” is decoded as a “0.” A missed bit error occurs when the receiver is unable to accurately determine if a received bit is a “0” or a “1.” In conventional data communication systems, whether synchronous or asynchronous, flipped bits and missed bits can be detected and corrected using any advanced error detection and correction routines.

However, in some cases, data transmission errors can take the form of extraneous bits or added bits in the received data packet. The additional bits are often inserted at the beginning of the data packet. The “added bit” errors are often referred to as “slipped bit” errors as the original bits in the received data packet have slipped from their correct positions. Slipped bit errors most often occur in asynchronous data communication systems.

In a synchronous transmission system where the transmitter and the receiver run at exactly the same clock frequency to a high degree of precision, the receiver can reliably receive the same number of bits that are transmitted by the transmitter, as long as the start of the data packet can be accurately found. However, in an asynchronous transmission system, the correct reception of the same number of bits in the transmitted data packet is more difficult. This is because in an asynchronous transmission system, the receiver's clock and the transmitter's clock may be very different and the receiver has to attempt to recover the clock from the incoming bit stream. Clock recovery is straightforward to carry out when the communication channel is clean. However, when noise, interference and distortion are superimposed on the transmitted data stream, rapid measurement of the transmitter's clock by the receiver is difficult. So difficult in fact that the receiver may interpret data distortion in the incoming data stream as valid data bits and begin producing 0's and 1's incorrectly as incoming data.

In some data communication systems, notably RF systems, the quality of the received data at the receiver increases as more bits are delivered. The improvement in reception can be a result of, for example, the RF components establishing the correct internal gain for the incoming RF signal. In such cases, the receiver suffers from poor bit detection only at the start of a packet while the bit detection improves as more data bits are being received. As a result, erroneous or extraneous bits often appear at the beginning of a received data packet. It is not possible to reliably correct for the “added bits” errors by using a longer preamble, that is, by appending redundant bits at the start of the data packet that contain no useful information. Regardless of how long the preamble is, the receiver can continue to suffer from slipped bit errors where the valid data bits are shifted by one or more bits from their correction positions due to erroneously detected bits inserted at the beginning of the data packet.

Unlike flipped bit or missed bit errors, the slipped bit errors may not be readily recognized by the conventional error detection and correction routines of the receiver. In fact, a received data packet with slipped bit errors may pass all internal error detection and correction checks and the receiver may end up accepting bad data as valid data.

FIG. 2 illustrates a transmitted data packet and a received data packet where the received data packet is corrupted by a slipped bit error. Referring to FIG. 2, assume that the communication system transmits data packets of 14 bits. If the receiver detects data distortion as two bits of incoming data, the receiver may end up inserting two additional bits (“Inserted Bits”) of data at the beginning of the received data packet. The valid data of the original transmitted data packet is thus slipped by two positions to the right.

The receiver will pass the first 14 bits it received, including 2 inserted bits and 12 valid data bits, as a complete data packet to the EDAC and CRC routines of the receiver, ignoring the last two bits of actual valid data (“Ignored Bits”). It is entirely possible that the 14 bits of received data packet will pass the EDAC routine with no bits corrected and will also pass the CRC test. If this occurs, the receiver will accept the data packet, even though the data packet is actually erroneous. The inability to detect slipped bit errors involving extraneous or added bits in the received data packet represents a major flaw in the data communications system.

### SUMMARY OF THE INVENTION

According to one embodiment of the present invention, a data communication method for transmitting a data packet from a transmitter to a receiver through a communication channel includes providing a key to the transmitter and the receiver where the key includes a K-bit data pattern sensitive to the location of each data bit in the data pattern; appending the key to the tail of the data packet; transmitting the data packet with the key to the receiver; receiving data bits at the receiver to form a received data packet; retrieving K data bits from the tail of the received data packet; and determining if the K data bits match the key. If the K data bits match the key, a first output signal having a first state indicating that the data packet is acceptable is provided. If the K data bits do not match the key, the first output signal having a second state indicating that the data packet should be rejected is provided.

In one embodiment, the data packet includes a data field containing data to be transmitted and an error correction field containing error correction data and the key is embedded in the error correction field of the data packet.

According to another aspect of the present invention, a receiver in a data communication system for receiving incoming data packets includes a bit detector for detecting data bits in an incoming data packets and providing a received data packet. The incoming data packet includes a data field and a key field appended to the tail of the data field where the key field contains data bits indicative of a key. The key includes a K-bit data pattern sensitive to the location of each data bit in the data pattern. The receiver further includes an error detection and correction block for detecting and correcting errors in the received data packet and providing a corrected received data packet, a key match block for retrieving K data bits from the key field and comparing the K data bits to the key. The key match block provides a first signal having a first state indicating the received data packet is acceptable when the K data bits match the key and having a second state indicating the received data packet should be rejected when the K data bits do not match the key. Lastly, the receiver includes a CRC block for performing cyclic redundancy check on the corrected received data packet.

In operation, the corrected received data packet is accepted when the corrected received data packet passes the cyclic redundancy check and the first signal has the first state and the corrected received data packet is rejected when the corrected received data packet fails the cyclic redundancy check or when the first signal has the second state.

The present invention is better understood upon consideration of the detailed description below and the accompanying drawings.

### BRIEF DESCRIPTION OF THE DRAWINGS

FIG. 1 illustrates a conventional data communication system.

FIG. 2 illustrates a transmitted data packet and a received data packet where the received data packet is corrupted by a slipped bit error.

FIG. 3 includes data packet structures illustrating the data communication method according to one embodiment of the present invention.

FIGS. 4A and 4B illustrate a “match” and a “no match” condition between a key and a lock.

FIG. 5 is a block diagram of a receiver implementing the data communication method according to one embodiment of the present invention.

FIG. 6 illustrates a data packet containing dummy data bits for error correction and a data packet modified to include a key embedded in the dummy data bits according to one embodiment of the present invention.

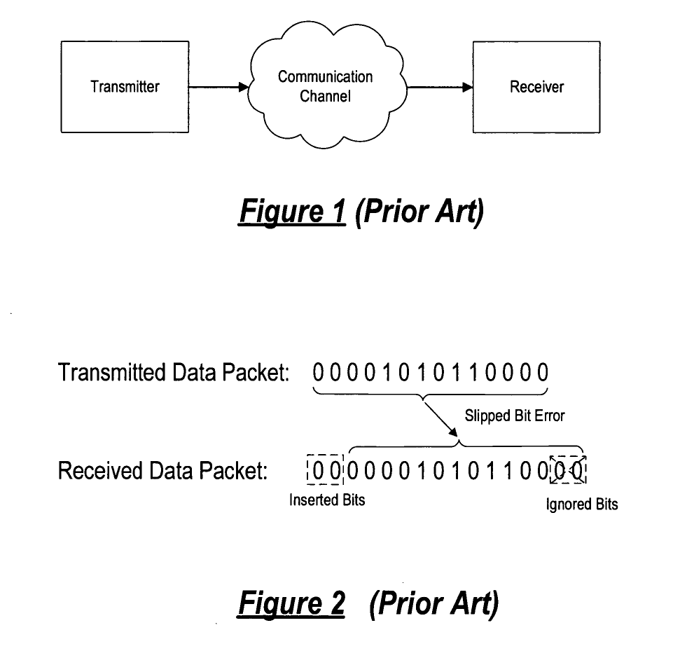

### DETAILED DESCRIPTION OF THE PREFERRED EMBODIMENTS

In accordance with the principles of the present invention, a data communication method for detecting slipped bit errors employs a key appended the tail end of a transmitted data packet. The key enables a receiver to determine if the data bits of a corresponding received data packet include added or extraneous bits, causing the valid data bits to slip from their correct positions in the data packet. The receiver receiving incoming data packets looks for the key at the tail end of each received data packet. If a matching key is found, the receiver accepts the data packet. If the data bits at the tail end of the received data packet do not match the key, the receiver rejects the data packet as including corrupted data. In this manner, the data communication method of the present invention provides a low cost and elegant means of detecting a difficult error condition, and successfully identifying and rejecting data streams which contain additional or extraneous data bits.

In one embodiment, the key is a multi-bit data pattern appended to the tail end of a data packet. In another embodiment, the key substitutes for dummy data bits that are normally included in the error correction field of a data packet. By using dummy data bits already present in the data packet, the additional overhead for implementing the method of the present invention is significantly reduced.

More specifically, the key is a multi-bit data pattern selected to enable ready identification of slipped bits in a received data packet. The key should have a data pattern that is sensitive to the exact location of the data bits in the key so that matching or non-matching of the key can be readily detected.

The data communication method of the present invention has particular application in a data communication system employing asynchronous serial data transmission. Asynchronous serial data transmission is particularly susceptible to slipped bit errors where one or more extraneous bits may be inserted into the beginning of a received data packet while the receiver attempts to retrieve the clock from the incoming data. The data communication method of the present invention can be advantageously employed in an asynchronous serial data transmission system to ensure that data packets with slipped bit errors are not accepted by the receiver, even when the data packet may pass all other error detection or correction checks.

Furthermore, the data communication method of the present invention is particularly useful in data communication system employing communication medium where data may be transmitted in the presence of random noise. The communication medium may include wired or wireless channels. Data communication systems employing the RF (radio frequency) communications channel is particularly error-prone. The data communication method of the present invention can be advantageously applied to improve error detection in an asynchronous serial data transmission system employing an RF communication channel.

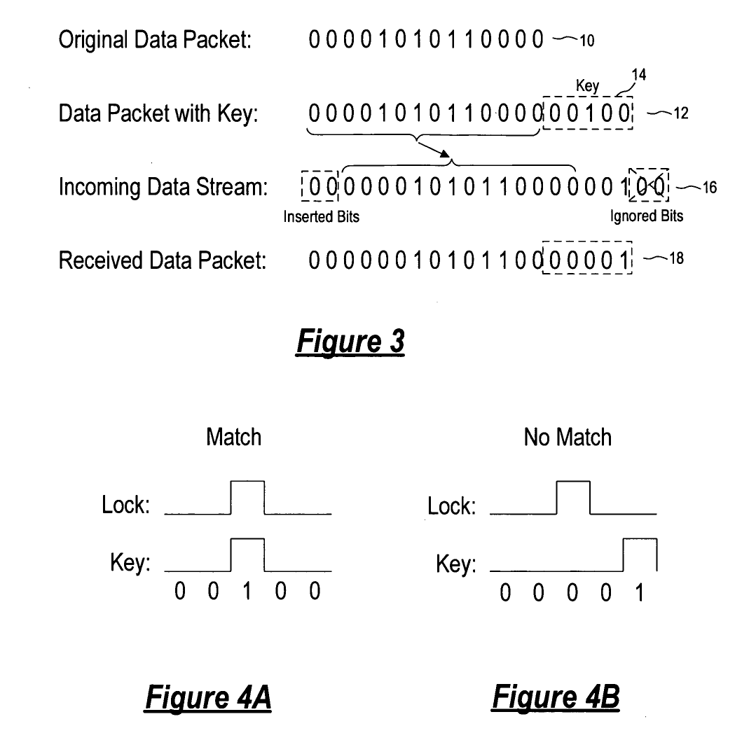

FIG. 3 includes data packet structures illustrating the data communication method according to one embodiment of the present invention. Referring to FIG. 3, it is assumed that data packets of 14 bits are being transmitted from a transmitter to a receiver. Thus, an original data packet 10 contains 14 bits of valid data to be transmitted. In accordance with the method of the present invention, a key is appended to the tail of the original data packet 10. In the present embodiment, the key is a 5-bit data pattern. A data packet 12 with a key 14 appended to the tail of the data packet is shown in FIG. 3. The data pattern of key 14 is selected to enable ready identification of slipped bits in a received data packet. The key should have a data pattern that is sensitive to the exact location of the data bits in the key so that matching or non-matching of the key can be readily detected. In the present embodiment, the key 14 has a bit pattern of 0 0 1 0 0. Thus, the location of the data bit 1 in the center of the bit pattern identifies the key uniquely to allow for detection of slipped bit. The data pattern for the key is provided to both the transmitter and the receiver of the data communication system.

Data packet 12, containing 14 bits of data and 5 bits of key, is transmitted from the transmitter to the receiver where the data packet may become corrupted. The receiver, upon receipt of a received data packet, examines the last 5 bits of the data pattern to determine if it matches the stored data pattern for the key—referred herein as the “lock”. If the received data packet does not contain slipped bit errors, the received data packet will contain a key at its tail that matches the lock stored in the receiver (FIG. 4A). In that case, the receiver passes the data packet to other error detection and correction routines that may be implemented in the communication system. When the received data packet passed all error checks, the receiver can then accept the data packet.

However, in cases where the receiver inadvertently inserts extraneous bits to the received data packet, the received data packet will suffer from slipped bit errors where the locations of valid data bits in the received data packet are actually shifted. Referring to FIG. 3, if the receiver inserts two additional bits to the beginning of the incoming data packet, the receiver will then receive the first 19 bits of the incoming data stream 16 and end up ignoring the last two bits of valid data. However, in accordance with the data communication method of the present invention, the receiver examines the last 5 bits of the received data packet 18 to determine if the key matches the data pattern of the lock pre-stored in the receiver. In this case, the data pattern of the key in the received data packet does not match the lock (FIG. 4B). The receiver therefore will reject the received data packet 18, even though the received data packet may pass other error detection and error correction routines.

In the above description, the key is a 5-bit data pattern. In other embodiments, the key is a multi-bit data pattern where the data pattern is sensitive to the exact location of the data bits in the key. For example, in an alternate embodiment, a 13-bit key can be used having the following data pattern: 0 0 0 0 0 0 1 0 0 0 0 0 0. A 13-bit key can detect data packets that have slipped up to six bit-places, which provides more than adequate protection against most slipped bit errors.

Furthermore, in the above description, the key is a multi-bit data pattern that is added to the existing data packet. Thus, the length of the transmitted data packet is increased. According to another aspect of the present invention, the data communication method of the present invention is implemented by embedding the key within the structure of the original data packet so that the key can be transmitted without requiring additional packet resources.

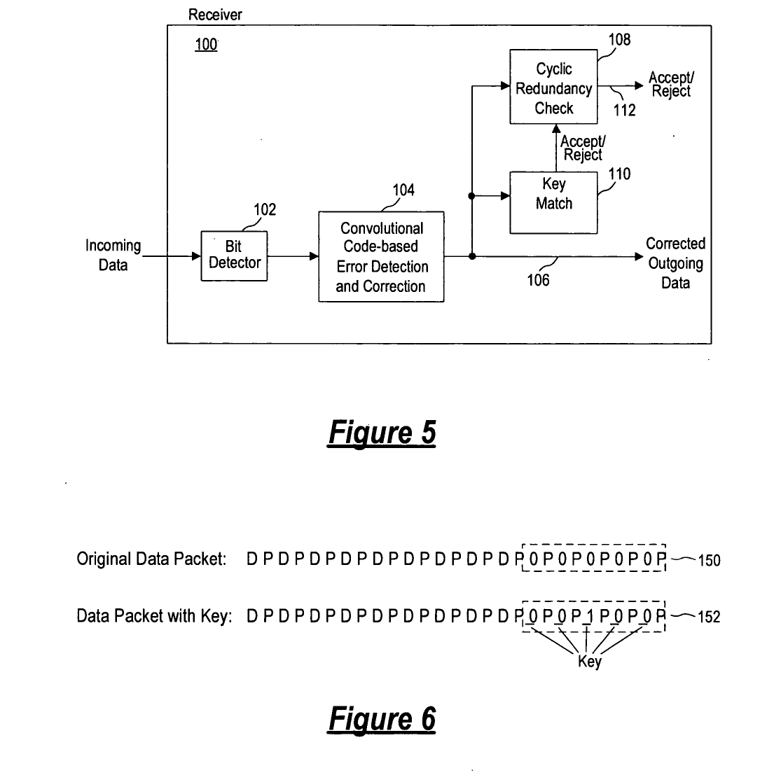

FIG. 5 is a block diagram of a receiver implementing the data communication method according to one embodiment of the present invention. Referring to FIG. 5, a receiver 100 is coupled to receive an incoming data stream and to provide corrected outgoing data on a lead 106. The receiver also provides a Reject/Accept signal on a lead 112. The incoming data stream is first passed to a Bit Detector 102, which outputs 0, 1, or a “miss” for each detected data bit. A miss represents an undecodable bit that does not truly represent a 0 or a 1.

The detected bits are passed to an error detection and correction block 104. In the present embodiment, the EDAC (error detection and correction) algorithm is based on a convolutional code. It is understood that a convolutional code for EDAC is exemplary only and that any code capable of actively correcting serial data may be employed. The EDAC algorithm uses the contents of the data stream to correct flipped bits on the fly. Missed bits are handled by, for example, always replacing the missed bit by a zero, and relying on the EDAC to correct the missed bit if needed.

After the EDAC block 104, the corrected data stream is passed to a CRC (cyclic redundancy check) block 108 to verify the data and provide robustness to the receiver. The CRC block 108 uses all the data in a certain region of the data stream to see if the information is internally consistent—that is, if all the bits “agree with each other.” If the data bits are inconsistent, the CRC block 108 outputs a “Reject” signal on lead 112. If the data bits are consistent, the CRC block 108 outputs an “Accept” signal on lead 112 and the corrected data stream is accepted as the corrected outgoing data.

To implement the data communication method of the present invention, the corrected data stream is also passed to a Key Match block 110. The Key Match block 110 determines if the corrected data stream contains the correct key and is therefore free from slipped bit errors. The Key Match block 110 provides an “Accept/Reject” signal which is coupled to the CRC block 108 to generate a combined Accept/Reject result for the received data packet. For instance, an incoming data stream may contain no slipped data error but fails the CRC routine. Thus, the Key Match block 110 will accept the data packet while the CRC routine will reject it. The final result is that the CRC block 108 will generate an output signal rejecting the data packet. On the other hand, an incoming data stream may contain slipped data error but pass the CRC routine. So while the CRC block may deem the data packet acceptable, the Key Match block will generate a signal to CRC block 108 indicating the received data packet should be rejected. The final result is also that the CRC block 108 will generate an output signal rejecting the data packet. A data packet is therefore accepted only when it is deemed acceptable by the Key Match block and the CRC block.

According to one aspect of the present invention, when the receiver implements traditional EDAC algorithm, the data communication method of the present invention can be practiced without requiring additional packet resource to implement the key. This is because all EDAC algorithms require the transmission of extra data bits used to correct errors at the receiver. That is, a data packet typically contains a preamble field, a data field, and an error correction field. The error correction field contains data for use in forward error correction of the data packet. Often, the error correction field contains dummy data whose specific value is not relevant to the receiver. The data communication method of the present invention utilizes these dummy data bits advantageously by embedding the key in the dummy data bits. In this manner, the key can be included in a data packet without requiring additional bits to be appended to the data packet.

FIG. 6 illustrates a data packet containing dummy data bits for error correction and a data packet modified to include a key embedded in the dummy data bits according to one embodiment of the present invention. Referring to FIG. 6, one type of EDAC algorithm encodes extra data bits in the data packet in two ways. First, throughout the length of the data packet, data bits (D) are encoded alternately with EDAC bits, known as parity bits (P). Then, after the last data bit, additional parity bits (P) are encoded for error correction. The additional parity bits (P) are appended to the end of the packet, in what is known as the packet's tail, forming the error correction field. Since there are no longer any valid data bits, the alternate data bit positions (D) are replaced by zeros where the zeros are dummy data bits. That is, the dummy data bits are not relevant to the EDAC algorithm at the receiver. A data packet 150 is thus encoded using this EDAC algorithm.

Thus, in accordance with the present invention, the key for detecting slipped bit error is embedded in the dummy data bits of the error correction field of data packet 150. For example, a 5-bit key pattern 0 0 1 0 0 is embedded into 5 bits of dummy data. A data packet 152 with an embedded key is thus obtained. By using the dummy data bits in the data packet's tail to encode and transmit the key, no overhead (additional bits) is imposed on the packet to send the key for slipped error detection. The data communication method of the present invention can thus be implemented with very low cost. The only burden on the data communication system is on the receiver to verify the correct match of the key.

The above detailed descriptions are provided to illustrate specific embodiments of the present invention and are not intended to be limiting. Numerous modifications and variations within the scope of the present invention are possible. The present invention is defined by the appended claims.

We claim:

1. A data communication method for transmitting a data packet from a transmitter to a receiver through a communication channel, the method comprising:
providing a key to the transmitter and the receiver, the key comprising a K-bit data pattern sensitive to the location of each data bit in the data pattern;
appending the key to the tail of the data packet;
transmitting the data packet with the key to the receiver;
receiving data bits at the receiver to form a received data packet;
retrieving K data bits from the tail of the received data packet;
determining if the K data bits match the key;
if the K data bits match the key, providing a first output signal having a first state indicating that the data packet is acceptable; and
if the K data bits do not match the key, providing the first output signal having a second state indicating that the data packet should be rejected.

2. The method of claim 1, further comprising:
applying error detection and correction routines on the received data packet before retrieving K data bits from the tail of the received data packet.

3. The method of claim 2, further comprising:
performing cyclic redundancy check on the received data packet;
generating a second output signal having a first state indicating the received data packet is accepted when the received data packet passes the cyclic redundancy check and the first output signal has the first state; and
generating the second output signal having a second state indicating the received data packet is rejected when the received data packet fails the cyclic redundancy check or when the first output signal has the second state.

4. The method of claim 1, wherein the key has a data pattern comprising K-1 data bits having a first logical state and one data bit having a second, opposite logical state disposed in the middle of the K-1 data bits.

5. The method of claim 4, wherein the key comprises a 13-bit key having the data pattern 0 0 0 0 0 0 1 0 0 0 0 0 0.

6. The method of claim 2, wherein the data packet comprises a data field containing data to be transmitted and an error correction field containing error correction data; and wherein:
the step of appending the key to the tail of the data packet comprises embedding the key in the error correction field of the data packet; and
the step of retrieving K data bits from the tail of the received data packet comprises retrieving K data bits embedded in the error correction field of the data packet.

7. A receiver in a data communication system for receiving incoming data packets, comprising:
a bit detector for detecting data bits in an incoming data packets and providing a received data packet, the incoming data packet comprising a data field and a key field appended to the tail of the data field, the key field containing data bits indicative of a key, the key comprising a K-bit data pattern sensitive to the location of each data bit in the data pattern;
an error detection and correction block for detecting and correcting errors in the received data packet, the error detection and correction block providing a corrected received data packet;
a key match block for retrieving K data bits from the key field and comparing the K data bits to the key, the key match block providing a first signal having a first state indicating the received data packet is acceptable when the K data bits match the key and having a second state indicating the received data packet should be rejected when the K data bits do not match the key; and
a CRC block for performing cyclic redundancy check on the corrected received data packet,
wherein the corrected received data packet is accepted when the corrected received data packet passes the cyclic redundancy check and the first signal has the first state and the corrected received data packet is rejected when the corrected received data packet fails the cyclic redundancy check or when the first signal has the second state.

8. The receiver of claim 7, wherein the key has a data pattern comprising K-1 data bits having a first logical state and one data bit having a second, opposite logical state disposed in the middle of the K-1 data bits.

9. The receiver of claim 7, wherein the key comprises a 13-bit key having the data pattern 0 0 0 0 0 0 1 0 0 0 0 0 0.

10. The receiver of claim 7, wherein the key field of the incoming data packet comprises error correction data and the data bits indicative of the key are embedded in the error correction data, the key match block retrieving the K data bits from the key field by retrieving the K data bits embedded in the error correction data.
